(19) United States
(12) Patent Application Publication
(10) Pub. No.: US 2026/0217566 A1
(43) Pub. Date: Jul. 30, 2026

(54) UNDER-SINK WATER PURIFIER

(71) Applicant: COWAY CO., LTD., Gongju-si (KR)

(72) Inventors: Hee Joo KANG, Gongju-si (KR); Jong Hwan LEE, Gongju-si (KR); Yoo Won OH, Gongju-si (KR); Hee Do JUNG, Gongju-si (KR); Byung Hyo YE, Gongju-si (KR)

(73) Assignee: COWAY CO., LTD., Gongju-si (KR)

(21) Appl. No.: 19/142,681

(22) PCT Filed: Dec. 4, 2023
(86) PCT No.: PCT/KR2023/019806

§ 371 Date: Jun. 24, 2025

(30) Foreign Application Priority Data
Dec. 29, 2022 (KR) 10-2022-0189222

(51) Int. Cl. C02F 1/00; B01D 29/56; B01D 35/18; B01D 35/30; E03C 1/02

(52) U.S. Cl. CPC C02F 1/003; B01D 29/56; B01D 35/18; B01D 35/303; E03C 1/02; B01D 2201/167; C02F 2201/004; C02F 2201/005; C02F 2201/007; C02F 2307/06

(57) ABSTRACT

A modular under-sink water purifier comprises: a main module and a faucet, wherein the main module includes: a main module housing having a first coupling part and a second coupling part provided, respectively, at one side portion and the other side portion thereof so that a portion of a sub-module; filters provided in the main module housing, and filtering raw water so as to produce purified water; and a first water discharge member and a second water discharge member provided, respectively, at one side of the first coupling part and one side of the second coupling part so that the purified water produced by means of the filters can be discharged to the outside of the main module housing, and the faucet can include a faucet housing, and a third water discharge member.

### TECHNICAL FIELD

The present invention relates to an under-sink water purifier and, more particularly, to an under-sink water purifier that can be installed in a sink.

### BACKGROUND

In general, a water purifier is an apparatus for purifying raw water supplied from a raw water supply source such as tap water or bottled water and supplies purified water to users by removing impurities, such as heavy metals and other harmful substances, contained in the raw water through physical or chemical methods such as precipitation, filtration, and sterilization. Among them, an under-sink water purifier is a water purifier installed in a sink.

Korean Patent Laid-Open Publication No. 2019-0092971 of LG Electronics Inc. discloses a conventional water dispensing apparatus. Such a water dispensing apparatus comprises an under-sink unit installed inside the sink to generate purified water or hot water and a faucet installed above the sink to dispense the generated purified water or hot water.

However, since such a water dispensing apparatus has a fixed shape for the under-sink unit installed inside the sink, it reduces the utilization efficiency of the internal space inside the sink and, furthermore, can only be installed in sinks that have a structure adapted to the shape of the under-sink unit.

In addition, such a water dispensing apparatus is configured so that a hot water module for generating hot water is installed inside the body of the under-sink unit. Therefore, replacing the hot water module with a water treatment module that provides a different function requires not only specialized knowledge of the structure of the under-sink unit but also the cumbersome process of disassembling and reassembling the under-sink unit itself.

Such a structural characteristic of the water dispensing apparatus makes it difficult to meet the needs of users who wish to selectively receive various water treatment functions, such as cold water, hot water, or carbonated water.

Korean Patent Laid-Open Publication No. 2021-0082955 of Kyowon Property Co., Ltd. discloses a conventional separate modulated water purifier. Such a separate modulated water purifier comprises a first main body module installed inside the sink to generate purified water, a second main body module that cools the purified water to generate cold water, and a water outlet unit installed above the sink.

Such a separate modulated water purifier is configured so that the second main body module receives purified water from the first main body module to generate cold water. To this end, the conventional separate modulated water purifier is equipped with a plurality of connection pipes to fluidically connect the first main body module and the second main body module.

However, in order to replace the second main body module with another main body module, multiple connection pipes must be disconnected from the second main body module and then reconnected to the other main body module. Accordingly, not only specialized knowledge of the structure of the water purifier but also the hassle of disassembling and reassembling the connection pipes is required.

Furthermore, since such a separate modulated water purifier is configured so that the first main body module can be fluidically connected to only one other main body module, there is a problem in that multiple water treatment modules providing different water treatment functions cannot be simultaneously connected to and used with the first main body module.

Such a structural characteristic of the separate modulated water purifier makes it difficult to meet the needs of users who wish to selectively receive various types of water treatment functions, such as cold water, hot water, or carbonated water.

### DISCLOSURE

### Technical Problem

The present invention has been devised in view of the above-described points, and the present invention is directed to providing an under-sink water purifier that can be installed in sinks of various structures.

The present invention is also directed to providing an under-sink water purifier that enhances space utilization of the internal space of the sink.

The present invention is also directed to providing an under-sink water purifier in which a main module and a sub-module, which are components of the purifier, can be easily and conveniently attached and detached without requiring specialized knowledge.

The present invention is also directed to providing an under-sink water purifier that meets the needs of users seeking various water treatment functions.

The present invention is also directed to providing an under-sink water purifier that meets the needs of users who wish to selectively receive only desired water treatment functions.

The problems of the present invention are not limited to those mentioned above, and other problems not mentioned will be clearly understood by those of ordinary skill in the art from the following description.

### Technical Solution

According to an aspect of the present invention, provided is a modular under-sink water purifier, including: a main module provided in a sink; and a faucet disposed outside the sink, wherein the main module includes: a main module housing having a first coupling part and a second coupling part provided, respectively, at one side portion and the other side portion thereof so that a portion of a sub-module, which can be detachably coupled to the main module, can be selectively coupled thereto; filters provided in the main module housing, and filtering raw water so as to produce purified water; and a first water discharge member and a second water discharge member provided, respectively, at one side of the first coupling part and one side of the second coupling part so that the purified water produced by means of the filters can be discharged to the outside of the main module housing, and wherein the faucet includes: a faucet housing; and a third water discharge member provided at the faucet housing so that the purified water supplied from the filters can be discharged to the outside.

In this case, the first coupling part may include a first bracket provided with a first coupling groove into which a portion of the sub-module can be inserted; a first locking member that is movably coupled to the first bracket, enabling movement to a locking position where the portion of the sub-module is engaged and a locking release position where the portion of the sub-module is spaced apart from the portion of the sub-module; and a first operating member provided on one side of the first locking member to allow movement of the first locking member, and one side of the first water discharge member may be positioned inside the first coupling groove.

In this case, one side of the first operating member may be provided with a button exposed to the outside of the main module housing, and the button may be configured to move the first operating member by being pressed inward into the main module housing by an external force, with one side of the button being connected to the first operating member.

In this case, the outer side of the main module housing may include a first sidewall provided with the first coupling part, the first sidewall may include a first portion adjacent to the sub-module coupled to the first coupling part and a second portion provided at an edge of the first portion, the first coupling groove may be disposed on the first portion of the first sidewall, and the first operating member may be disposed on the second portion of the first sidewall.

In this case, the second coupling part may include a second bracket provided with a second coupling groove into which a portion of the sub-module can be inserted; a second locking member that is movably coupled to the second bracket, enabling movement to a locking position where the portion of the sub-module is engaged and a locking release position where the portion of the sub-module is spaced apart from the portion of the sub-module; and a second operating member provided on one side of the second locking member to allow movement of the second locking member, and one side of the second water discharge member may be positioned inside the second coupling groove.

In this case, the outer side of the main module housing may include a second sidewall provided with the second coupling part, the second sidewall may include a first portion adjacent to the sub-module coupled to the second coupling part and a second portion provided at an edge of the first portion, the second coupling groove may be positioned on the second portion of the second sidewall, and the second operating member may be positioned on the second portion of the second sidewall.

In this case, the main module housing may extend in the front-rear direction and have a box shape in which the first sidewall and the second sidewall are provided at opposite sides, the first operating member may be positioned at the front portion of the first sidewall, and the second operating member may be positioned at the rear portion of the second sidewall.

In this case, the under-sink water purifier may further include a first sub-module disposed adjacent to the main module, the first sub-module may include a first sub-module housing having a first corresponding coupling part provided at one side thereof to be selectively coupled to one of the first coupling part and the second coupling part; a first corresponding water inlet member provided at one side of the first corresponding coupling part to be selectively and fluidically connected to one of the first water discharge member and the second water discharge member; and a first sub-module-side water treatment unit configured to receive purified water from the first corresponding water inlet member and heat or cool it, and the third water discharge member may be configured to receive the purified water cooled or heated by the first sub-module-side water treatment unit.

In this case, the under-sink water purifier may further include a second sub-module disposed adjacent to the main module, the second sub-module may include a second sub-module housing having a second corresponding coupling part provided at one side thereof to be selectively coupled to the other one of the first coupling part and the second coupling part; a second corresponding water inlet member provided at one side of the second corresponding coupling part to be selectively and fluidically connected to the other one of the first water discharge member and the second water discharge member; and a second sub-module-side water treatment unit configured to receive purified water from the second corresponding water inlet member and heat or cool it, and the third water discharge member may be configured to receive the purified water cooled or heated by the second sub-module-side water treatment unit.

In this case, the first sub-module-side water treatment unit may be a cold water generation unit configured to cool purified water to generate cold water, and the second sub-module-side water treatment unit may be a hot water generation unit configured to heat purified water to generate hot water.

In this case, the main module housing may include, at the outer side thereof, a first sidewall provided with the first coupling part and a second sidewall provided with the second coupling part, and the first sidewall and the second sidewall may be disposed to face each other.

In this case, the main module may include a main module-side water treatment unit provided inside the main module housing and configured to receive purified water from the filters and perform heating or cooling.

In this case, the faucet may include an ice generation unit configured to receive purified water from the filters and generate ice; and an ice discharge member configured to discharge the ice generated by the ice generation unit to the outside.

In this case, the main module may include a piping member having a purified water inlet portion configured to receive purified water from the filters; a first extension portion extending in one direction from one side of the purified water inlet portion to supply purified water to the first water discharge member; and a second extension portion extending in the opposite direction from the one side of the purified water inlet portion to supply purified water to the second water discharge member.

In this case, a check valve may be provided on one side of the first water discharge member and the second water discharge member, respectively, and the check valve may be configured to prevent purified water from being discharged to the outside of the main module housing when the sub-module is not coupled to the main module.

In this case, the main module may include a third coupling part and a fourth coupling part provided on the outer side of the main module housing to allow another part of the sub-module to be selectively coupled thereto; and a first water inlet member and a second water inlet member respectively provided on one side of the third coupling part and one side of the fourth coupling part to allow purified water discharged from the sub-module to be introduced into the main module housing, and the third coupling part may be disposed to be spaced apart from one side of the first coupling part, and the fourth coupling part may be disposed to be spaced apart from one side of the second coupling part.

In this case, the under-sink water purifier may further include a first sub-module disposed adjacent to the main module, the first sub-module may include a first sub-module housing having a first water inlet-side corresponding coupling part selectively coupled to one of the first coupling part and the second coupling part, and a first water discharge-side corresponding coupling part selectively coupled to one of the third coupling part and the fourth coupling part, the first water inlet-side corresponding coupling part and the first water discharge-side corresponding coupling part being provided on the outer side of the first sub-module housing; a first corresponding water inlet member provided at one side of the first water inlet-side corresponding coupling part to be selectively and fluidically connected to one of the first water discharge member and the second water discharge member; a first sub-module-side water treatment unit configured to receive purified water from the first sub-module-side water inlet member and heat or cool it; and a first corresponding water discharge member provided on the first water discharge-side corresponding coupling part to be selectively and fluidically connected to one of the first water inlet member and the second water inlet member so as to discharge purified water, supplied from the first sub-module-side water treatment unit, to the outside of the first sub-module housing, and the first water discharge-side corresponding coupling part may be disposed to be spaced apart from one side of the first water inlet-side corresponding coupling part, and the third water discharge member may be configured to receive the purified water cooled or heated by the first sub-module-side water treatment unit.

### Advantageous Effect

The under-sink water purifier according to an exemplary embodiment of the present invention is configured such that a sub-module can be selectively coupled to either side of the main module, allowing for adjustment of the relative arrangement of the main module and the sub-module. As a result, it can be installed in sinks of various structures and enhances space utilization of the internal space of the sink.

In addition, the under-sink water purifier according to an exemplary embodiment of the present invention is coupled as the sub-module is disposed adjacent to a first portion of the first sidewall of the main module. This allows the sub-module and main module to be arranged compactly, thereby enhancing space utilization of the internal space of the sink.

In addition, the under-sink water purifier according to an exemplary embodiment of the present invention is configured such that the coupling part of the main module and the corresponding coupling part of the sub-module are detachably coupled, so that a water discharge member provided on one side of the coupling part and a corresponding water inlet member provided on one side of the corresponding coupling part are fluidically connected. As a result, both the structural coupling and the fluidic connection of the main module and the sub-module can be performed simultaneously, making it easy and convenient to attach and detach the main module and sub-module without requiring specialized knowledge.

In addition, the under-sink water purifier according to an exemplary embodiment of the present invention is configured such that a locking member, which can engage or disengage the corresponding coupling part of the sub-module, is operated by an operating member that can be manipulated by the user. As a result, the coupling and uncoupling of the main module and the sub-module can be easily and conveniently performed without requiring specialized knowledge.

In addition, the under-sink water purifier according to an exemplary embodiment of the present invention is configured such that an operating member, which can be manipulated to control the coupling and uncoupling of the main module and the sub-module, is disposed on a second portion of the main housing. As the operating member remains accessible even when the sub-module and the main module are coupled, the coupling and uncoupling of the main module and the sub-module can be easily, conveniently, and intuitively performed without requiring specialized knowledge.

In addition, the under-sink water purifier according to an exemplary embodiment of the present invention is configured such that both the main module and the sub-module can include a water treatment unit, respectively, and the faucet can include an ice generation unit, thereby meeting the needs of users who desire to receive a variety of water treatment functions.

In addition, the under-sink water purifier according to an exemplary embodiment of the present invention provides multiple sub-modules capable of offering different water treatment functions. Among these sub-modules, some can be selectively coupled to the main module for use, thereby meeting the needs of users who wish to selectively receive only the desired functions.

Advantageous effects of embodiments of the present invention are not limited to the above-described effects, and other effects not mentioned will be clearly understood by those of ordinary skill in the art from the present specification and the accompanying drawings.

### BRIEF DESCRIPTION OF THE DRAWINGS

FIGS. 1 and 2 are perspective views from above showing an under-sink water purifier installed in a sink according to an exemplary embodiment of the present invention. In this case, the sink is indicated by a dashed line, and the components visible through the sink are indicated by solid lines.

FIG. 3 is a schematic diagram illustrating an under-sink water purifier according to an exemplary embodiment of the present invention.

FIG. 4 is an exploded perspective view of a main module of an under-sink water purifier and a sub-module coupled to the left side of the main module according to an exemplary embodiment of the present invention.

FIG. 5 is an enlarged view of a portion of FIG. 4, showing the first coupling part and the first water discharge member of the main module according to an exemplary embodiment of the present invention.

FIG. 6 is a cross-sectional view showing the state in which the first water discharge member of the main module and the corresponding water inlet member of the sub-module are coupled to each other, according to an exemplary embodiment of the present invention.

FIG. 7 is an enlarged view of a portion of FIG. 4, showing the corresponding coupling part and the corresponding water inlet member of the sub-module, according to an exemplary embodiment of the present invention.

FIG. 8 is a perspective view from above showing a main module of an under-sink water purifier and a sub-module coupled to the right side of the main module according to an exemplary embodiment of the present invention.

FIG. 9 is an exploded perspective view of a main module of an under-sink water purifier and a sub-module coupled to the right side of the main module according to an exemplary embodiment of the present invention.

FIG. 10 is a perspective view from above showing a main module and a sub-module coupled to the left side of the main module, according to a modified example of the embodiment of the present invention.

FIG. 11 is an exploded perspective view of the main module and sub-module shown in FIG. 10.

FIG. 12 is a schematic diagram illustrating an under-sink water purifier according to a modified example of the embodiment of the present invention.

### BEST MODES FOR CARRYING OUT THE INVENTION

The present invention discloses a modular under-sink water purifier, which includes a main module provided inside the sink and a faucet arranged outside the sink, in its best mode. The main module includes a main module housing having a first coupling part and a second coupling part provided, respectively, at one side portion and the other side portion thereof so that a portion of a sub-module, which can be detachably coupled to the main module, can be selectively coupled thereto; filters provided in the main module housing, and filtering raw water so as to produce purified water; and a first water discharge member and a second water discharge member provided, respectively, at one side of the first coupling part and one side of the second coupling part so that the purified water produced by means of the filters can be discharged to the outside of the main module housing.

The faucet includes a faucet housing; and a third water discharge member provided at the faucet housing so that the purified water supplied from the filters can be discharged to the outside.

### Modes of the Invention

Terms and words used in the present specification and claims should not be construed as limited to their usual or dictionary definition. They should be interpreted as meaning and concepts consistent with the technical idea of the present invention, based on the principle that inventors may appropriately define the terms and concepts to describe their own invention in the best way.

It should be understood that the terms “comprise or include” or “have” or the like when used in this specification, are intended to describe the presence of stated features, numbers, steps, operations, elements, components and/or a combination thereof but not preclude the possibility of the presence or addition of one or more other features, numbers, steps, operations, elements, components, or a combination thereof.

The presence of an element in/on “front”, “rear”, “upper or above or top” or “lower or below or bottom” of another element includes not only being disposed in/on “front”, “rear”, “upper or above or top” or “lower or below or bottom” directly in contact with other elements, but also cases in which another element being disposed in the middle, unless otherwise specified. In addition, unless otherwise specified, that an element is “connected” to another element includes not only direct connection to each other but also indirect connection to each other.

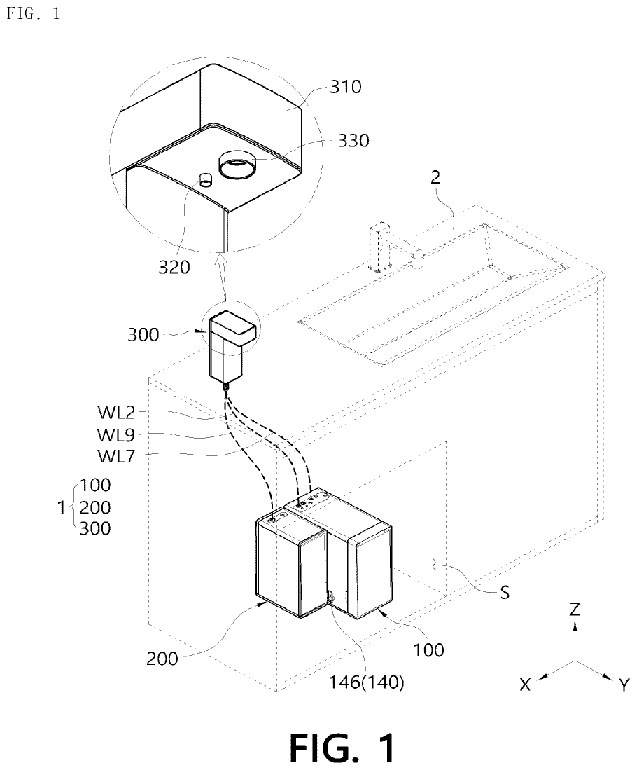

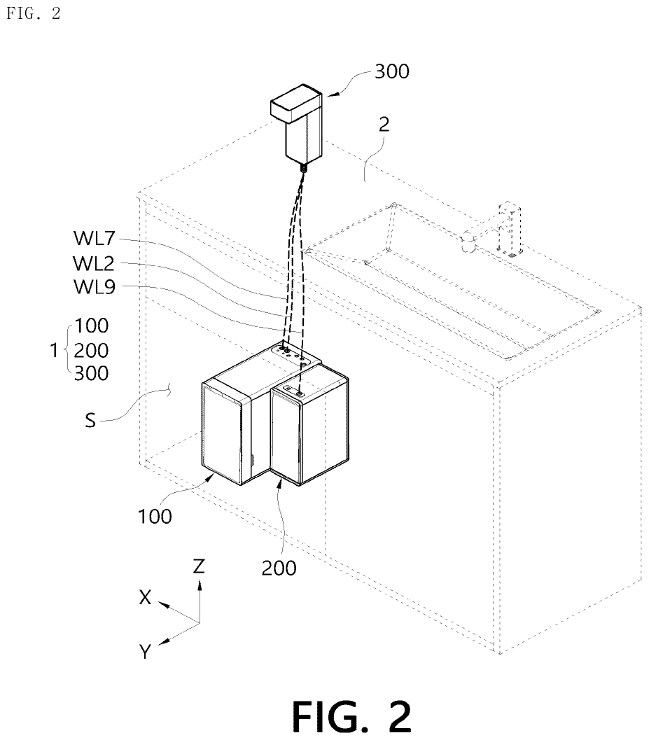

FIGS. 1 and 2 are perspective views from above showing an under-sink water purifier installed in a sink according to an exemplary embodiment of the present invention. In this case, the sink is indicated by a dashed line, and the components visible through the sink are indicated by solid lines.

Hereinafter, in describing drawings, it will be described based on the coordinate axis shown in FIG. 1. More specifically, the direction of the x-axis in FIG. 1 is defined as the leftward direction, and the opposite direction is defined as the rightward direction. The direction of the y-axis in FIG. 1 is defined as the forward direction, and the opposite direction is defined as the rearward direction. Additionally, the direction of the z-axis in FIG. 1 is defined as the upward direction, and the opposite direction is defined as the downward direction.

Referring to FIGS. 1 and 2, the under-sink water purifier 1 according to an exemplary embodiment of the present invention is a water purifier that can be installed in a sink 2, and it may include a main module 100 and a sub-module 200 that can be installed in the internal space S of the sink 2 and detachably coupled to each other, as well as a faucet 300 that can be provided above the sink 2.

In this case, the main module 100 may be configured to provide the original function of the water purifier by filtering raw water to produce purified water, and the sub-module 200 may be configured to perform water treatment on the produced purified water. And the faucet 300 may be configured to discharge the purified water produced or treated by the main module 100 or the sub-module 200 to the outside.

To this end, the main module 100, the sub-module 200, and the faucet 300 may be fluidically connected to each other through a predetermined flow path. And the main module 100, the sub-module 200, and the faucet 300 may also have a predetermined flow path provided inside them. Such a flow path may be made of flexible hoses, pipes, or the like.

In this specification, “water treatment” refers to processing the purified water to have specific characteristics according to the user's preferences, such as heating the purified water to produce hot water, cooling the purified water to produce cold water, injecting carbon dioxide into the purified water to produce carbonated water, or adding a predetermined flavor to the purified water.

As such, the under-sink water purifier 1 according to an exemplary embodiment of the present invention can be configured such that the sub-module 200 is coupled to the main module 100 to provide both purified water and treated water, or the main module 100 is arranged alone to provide only purified water. Thus, this allows the user to selectively choose only the desired functions, thereby meeting a variety of consumer needs.

In addition, according to the present embodiment, as shown in FIGS. 1 and 2, the sub-module 200 can be selectively coupled to either side portion of the main module 100, so that the main module 100 and the sub-module 200 can be appropriately arranged in various forms of the internal space(S), thereby enhancing the space utilization of the internal space(S).

Hereinafter, a more detailed description of the under-sink water purifier according to an exemplary embodiment of the present invention will be provided.

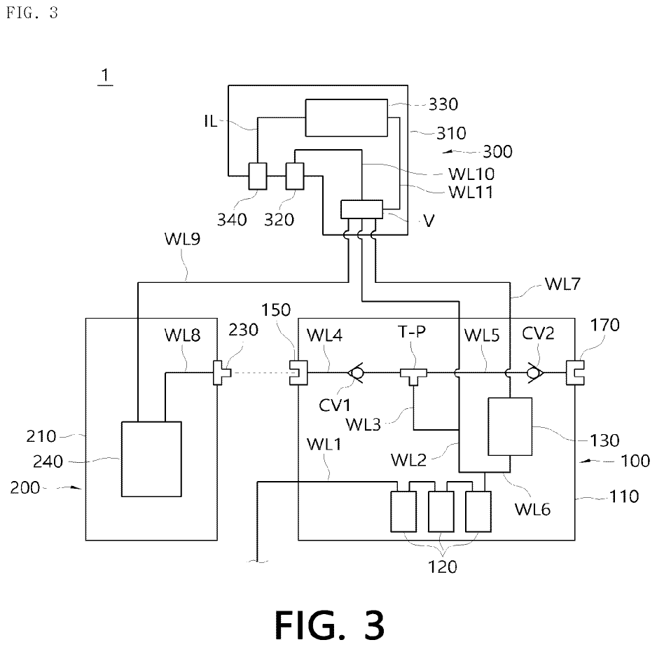

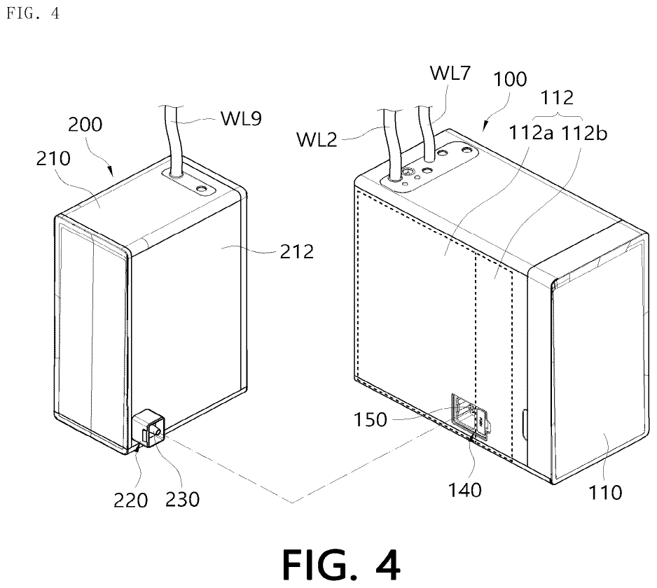

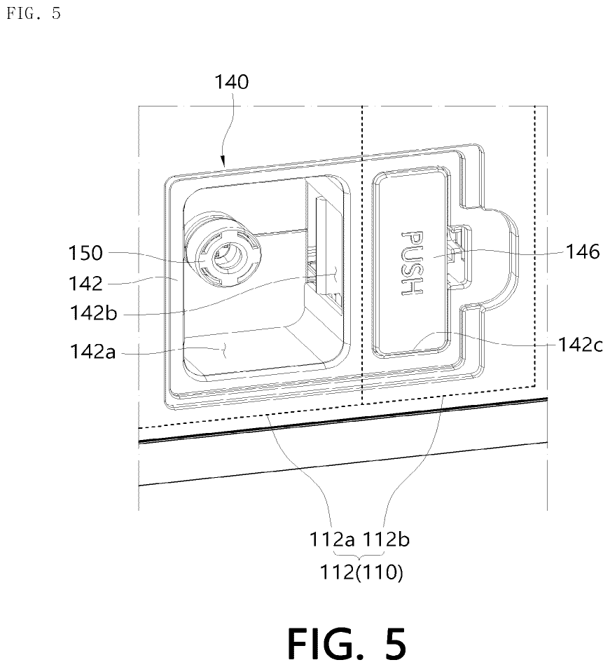

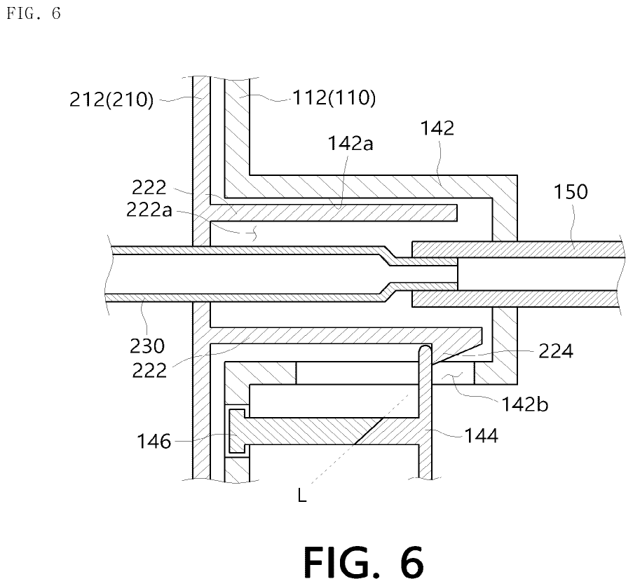

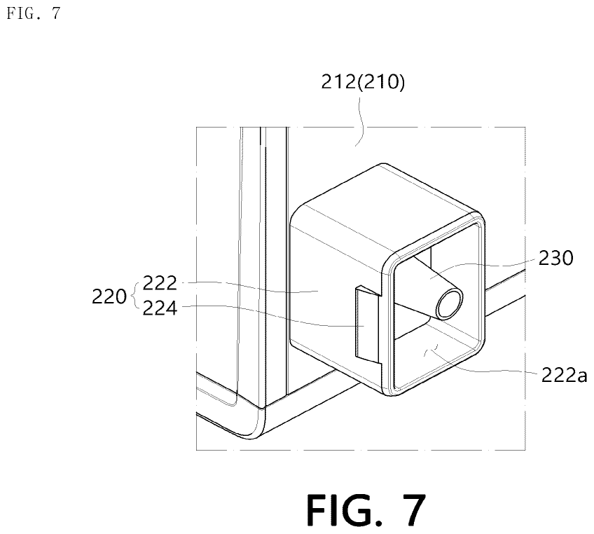

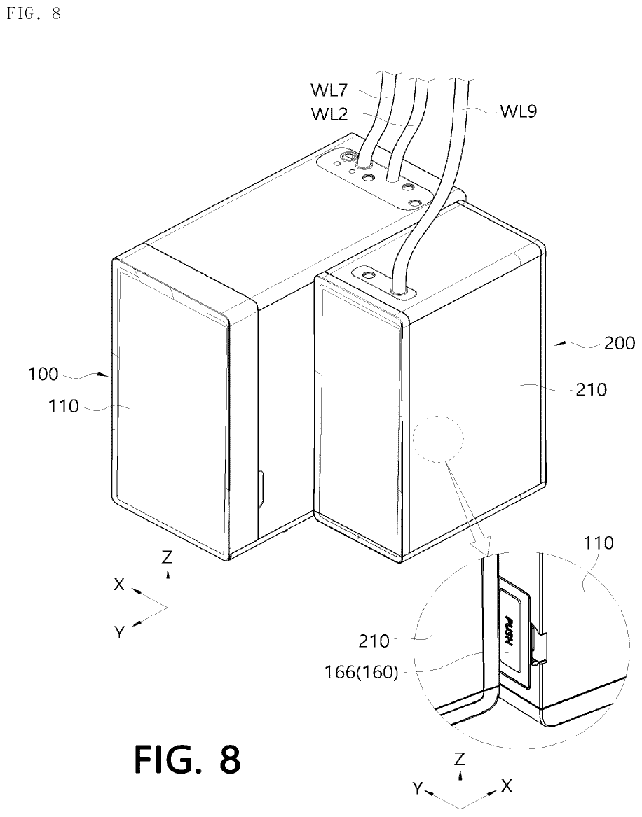

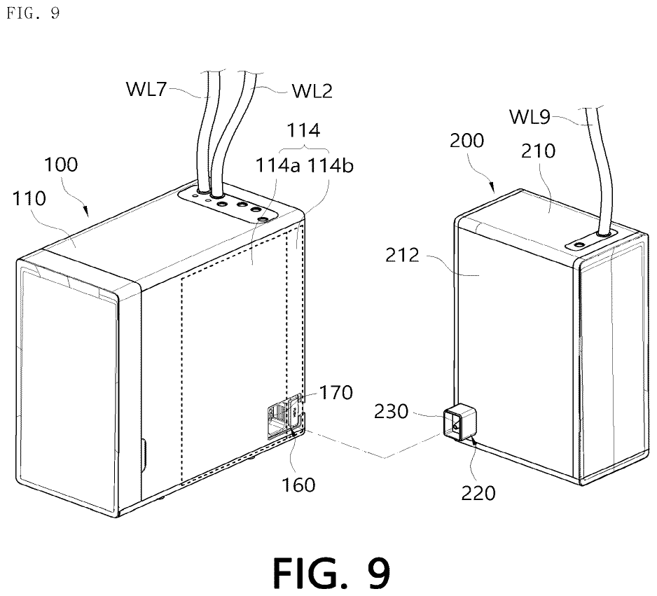

FIG. 3 is a schematic diagram illustrating an under-sink water purifier according to an exemplary embodiment of the present invention. FIG. 4 is an exploded perspective view of a main module of an under-sink water purifier and a sub-module coupled to the left side of the main module according to an exemplary embodiment of the present invention. FIG. 5 is an enlarged view of a portion of FIG. 4, showing the first coupling part and the first water discharge member of the main module according to an exemplary embodiment of the present invention. FIG. 6 is a cross-sectional view showing the state in which the first water discharge member of the main module and the corresponding water inlet member of the sub-module are coupled to each other, according to an exemplary embodiment of the present invention. FIG. 7 is an enlarged view of a portion of FIG. 4, showing the corresponding coupling part and the corresponding water inlet member of the sub-module, according to an exemplary embodiment of the present invention. FIG. 8 is a perspective view from above showing a main module of an under-sink water purifier and a sub-module coupled to the right side of the main module according to an exemplary embodiment of the present invention. FIG. 9 is an exploded perspective view of a main module of an under-sink water purifier and a sub-module coupled to the right side of the main module according to an exemplary embodiment of the present invention.

Referring to FIGS. 1 to 3, the under-sink water purifier 1 according to an exemplary embodiment of the present invention may include a main module 100. The main module 100 is the basic component of the under-sink water purifier 1 and can perform the function of filtering raw water to produce purified water.

To this end, the main module 100 may include a main housing 110 and a filter 120. In this embodiment, the main housing 110 may accommodate and protect other components of the main module 100 or provide a base on which they can be provided.

Referring to FIGS. 4 and 9, in one embodiment of the present invention, the main housing 110 is made of a box-shaped structure with a rectangular parallelepiped shape. Additionally, the sub-module 200, which will be described later, may be selectively coupled to the left and right sides of the main housing 110. Hereinafter, a sidewall provided on the left side of the main housing 110 is referred to as a first sidewall 112, and a sidewall provided on the right side is referred to as a second sidewall 114.

In this case, referring to FIG. 4, in this embodiment, the first sidewall 112 of the main housing 110 may be composed of a first portion 112a and a second portion 112b. The first portion 112a is a portion covered adjacent to the sub-module 200 coupled to the left side of the main housing 110, and the second portion 112b is a portion positioned in front of an edge of the first portion 112a.

Similarly, referring to FIG. 9, in this embodiment, the second sidewall 114 of the main housing 110 may be composed of a first portion 114a and a second portion 114b. The first portion 114a is a portion covered adjacent to the sub-module 200 coupled to the right side of the main housing 110, and the second portion 114b is a portion positioned in rear of an edge of the first portion 114a.

That is, when the sub-module 200 is coupled to the left side of the main module 100, access to the first portion 112a of the first sidewall 112 will be blocked, while access to the second portion 112b will be possible. Similarly, when the sub-module 200 is coupled to the right side of the main module 100, access to the first portion 114a of the second sidewall 114 will be blocked, while access to the second portion 114b will be possible. This will be described in detail later together with the first coupling part 140 and the second coupling part 160.

Meanwhile, the shape of the main housing 110 is not particularly limited as long as it can accommodate and protect other components of the main module 100 and may be modified into various forms, such as having a curved portion as needed.

Referring to FIG. 3, in this embodiment, a filter 120 is provided inside the main housing 110. The filter 120 is a component for filtering raw water to produce purified water and may be provided in plurality as needed. A first flow path (WL1) may be fluidically connected to one side of the filter 120.

According to an exemplary embodiment of the present invention, the first flow path (WL1) can function to supply raw water from the outside to the filter 120. To this end, the first flow path (WL1) may extend to the outside through the main housing 110.

And, in an embodiment of the present invention, a second flow path (WL2), through which the purified water generated by the filter 120 can flow, may be fluidically connected to the other side of the filter 120. Such a second flow path (WL.2) may extend to the outside through the main housing 110 and be fluidically connected to a flow path control valve (V) of the faucet 300, which will be described later. Accordingly, the purified water generated by the filter 120 can be introduced into the flow path control valve (V).

At this point, referring again to FIG. 3, in an embodiment of the present invention, a third flow path (WL3) may branch off from the second flow path (WL2). Accordingly, the purified water flowing from the second flow path (WL2) may flow into the third flow path (WL3).

And, in this embodiment, a T-shaped piping member (T-P) may be provided in the third flow path (WL3). The T-shaped piping member (T-P) can branch the purified water flowing through the third flow path (WL3) into multiple flow paths.

To this end, in this embodiment, the T-shaped piping member (T-P) may include a purified water inlet portion connected to the third flow path (WL3), a first extension portion extending to the left from the top of the purified water inlet portion, and a second extension portion extending to the right from the top of the purified water inlet portion, as shown in FIG. 3.

In this case, according to an exemplary embodiment of the present invention, the first extension portion of the T-shaped piping member (T-P) may be fluidically connected to a fourth flow path (WL4), and the second extension portion may be connected to a fifth flow path (WL5), as will be described later.

Accordingly, a portion of the purified water flowing through the third flow path (WL3) may be introduced into the fourth flow path (WL4), and the remainder may be introduced into the fifth flow path (WL5). Meanwhile, the T-shaped piping member (T-P) may be replaced with various known piping members capable of branching the incoming fluid into multiple flow paths.

Referring to FIGS. 3 and 4, in an embodiment of the present invention, the first sidewall 112 of the main housing 110 may be provided with a first coupling part 140. The first coupling part 140 is a component configured to detachably couple the main module 100 and the sub-module 200, which will be described later. That is, the sub-module 200 may be coupled to the left side of the main housing 110 by the first coupling part 140.

Referring to FIGS. 4 to 6, in this embodiment, the first coupling part 140 may include a first bracket 142, a first locking member 144, and a first operating member 146.

In this embodiment, the first bracket 142 may be positioned at the lower front side of the first sidewall 112. In this case, the rear portion of the first bracket 142 may be positioned on the first portion 112a of the first sidewall 112, and the front portion of the first bracket 142 may be positioned on the second portion 112b.

In this embodiment, a first coupling groove 142a recessed concave toward the inside of the main housing 110 may be formed at the rear portion of the first bracket 142. In this case, the first coupling groove 142a may have a rectangular cross-section corresponding to an insertion member 222 of the sub-module 200 to be described later. A first through hole 142 b may be formed in the front portion of the inner circumferential surface of the first coupling groove 142a.

In addition, a first operation hole 142c may be formed in the front portion of the first bracket 142 located in the second portion 112b of the first sidewall 112.

Meanwhile, according to an exemplary embodiment of the present invention, a first operating member 146 may be provided at the front portion of the first bracket 142. The first operating member 146 may have a shape that can be operated by a user.

For example, as shown in the drawings, one side of the first operating member 146 may have a button shape. The one side of the first operating member 146 may be exposed to the outside through the first operation hole 142c, so that it can be pressed inward into the inside of the main

### Housing 110 by an External Force.

As such, according to the present embodiment, as the first operating member 146 is provided in a button shape, allowing the user to intuitively recognize it as an operable component, user convenience can be enhanced.

Meanwhile, in this embodiment, referring to FIG. 6, the other side of the first operating member 146 may extend from one side of the first operating member 146 into the inside of the main housing 110. The end of the other side of the first operating member 146 may be formed to incline inward toward the inside of the main housing 110 as it extends toward the direction of the first through hole 142b.

In this case, although not shown, a return spring may be provided at one side of the first operating member 146 to ensure that the first operating member 146 is positioned at a predetermined location when no external force is applied.

Meanwhile, referring to FIGS. 5 and 6, in an embodiment of the present invention, the first locking member 144 may be disposed at one side of the first bracket 142. The first locking member 144 is configured to couple or uncouple the main module 100 and the sub-module 200 as it is operated by the first operating member 146.

In this embodiment, the first locking member 144 may be provided to be positioned at an engagement position where one side thereof protrudes inward into the first coupling groove 142a through the first through hole 142b or at a disengagement position where it is withdrawn from the first through hole 142b and located inside the main housing 110. In addition, the first locking member 144 may be configured to move from the engagement position to the disengagement position or in the opposite direction.

The other side of the first locking member 144 may be configured to come into contact with the inclined end of the other side of the first operating member 146. More specifically, the other side of the first locking member 144 may be formed to be inclined outward of the main housing 110 as it extends away from the first through hole 142b. Accordingly, the other side of the first locking member 144 and the other side of the first operating member 146 may come into contact along a predetermined inclined surface (L).

Referring to FIG. 7, in this embodiment, when the first operating member 146 is pressed inward into the main housing 110 by an external force, the other side of the first locking member 144 is pushed along the predetermined inclined surface (L). Accordingly, the first locking member 144 may be moved from the engagement position to the disengagement position.

Meanwhile, although not illustrated, a predetermined return spring may be provided on one side of the first locking member 144 to position the first locking member 144 at the engagement position when no external force is applied to the first operating member 146.

Referring again to FIGS. 4 to 6, a first water discharge member 150 may be provided on one side of the first bracket 142 of the first coupling part 140. The first water discharge member 150 may be formed of a pipe, valve, or the like through which fluid can flow.

In this case, the first water discharge member 150 may penetrate through the first bracket 142. And one end of the first water discharge member 150 may be positioned inside the first coupling groove 142a of the first bracket 142.

Accordingly, one end of the first water discharge member 150 may be exposed to the outside of the main housing 110. The first water discharge member 150 may be fluidically connected to the corresponding water inlet member 230 of the sub-module 200, which will be described later, through an end exposed to the outside.

In this case, referring to FIG. 3, in this embodiment, a fourth flow path (WL4) as described above may be provided between the first water discharge member 150 and the T-shaped piping member (T-P). The fourth flow path (WL4) fluidically connects the first water discharge member 150 and the T-shaped piping member (T-P).

Accordingly, the purified water flowing through the third flow path (WL3) may be introduced into the first water discharge member 150 through the fourth flow path (WL4) and then be discharged to the outside of the main module 100 through the first water discharge member 150. As will be described in more detail later, the purified water discharged to the outside of the main module 100 may be introduced into the sub-module 200 to be water-treated.

And according to an exemplary embodiment of the present invention, a first check valve (CV1) may be provided in the fourth flow path (WL4). The first check valve (CV1) is configured to prevent fluid from flowing back from the first water discharge member 150 to the fourth flow path (WL4).

In addition, the first check valve (CV1) may also function to control the fluid flow so that purified water can flow from the fourth flow path (WL4) to the first water discharge member 150 only when the first water discharge member 150 is fluidically connected to the corresponding water inlet member 230, which will be described later.

Through this, the purified water flowing through the fourth flow path (WL4) may be forced to be discharged into the sub-module 200 through the first water discharge member 150.

Meanwhile, referring to FIGS. 3, 8, and 9, in an embodiment of the present invention, a second coupling part 160 and a second water discharge member 170 may be provided on the second sidewall 114 of the main housing 110.

The second coupling part 160 may be positioned at the lower rear side of the second sidewall 114, and the second water discharge member 170 may be provided on one side of the second coupling part 160. And the second coupling part 160 may include a second bracket, a second locking member, and a second operating member 166.

In this case, according to the present embodiment, since the second bracket, the second locking member, the second operating member, and the second water discharge member 170 of the second coupling part 160 may be configured similarly to the first bracket 142, the first locking member 144, the first operating member 146, and the first water discharge member 150 of the first coupling part 140, a detailed description thereof will be omitted, and reference will be made to the descriptions of the first coupling part 140 and the first water discharge member 150.

Meanwhile, referring to FIG. 3, in this embodiment, the fifth flow path (WL5) as described above may be provided between the second water discharge member 170 and the T-shaped piping member (T-P). The fifth flow path (WL5) may fluidically connect the second water discharge member 170 and the T-shaped piping member (T-P). In this case, a second check valve (CV2) may be provided in the fifth flow path (WL5).

The second check valve (CV2) may perform the same function with respect to the fifth flow path (WL5) and the second water discharge member 170 as the first check valve (CV1) performs with respect to the fourth flow path (WL4) and the first water discharge member 150.

According to an aspect of the present invention, the main module 100 may further include a main module-side water treatment unit 130. The main module-side water treatment unit 130 may be composed of various known configurations capable of water treatment, as described above. For example, the main module-side water treatment unit 130 may be composed of a hot water generation unit, a cold water generation unit, a carbonated water generation unit, a flavor addition unit, or the like.

In this embodiment, the main module-side water treatment unit 130 is accommodated inside the main housing 110 and protected from the outside. And, the main module-side water treatment unit 130 may be fluidically connected to a sixth flow path (WL6) to receive purified water generated by the filter 120. In this case, the sixth flow path (WL6) may be a flow path branched from the second flow path (WL2). Accordingly, purified water flowing through the second flow path (WL.2) may be introduced into the main module-side water treatment unit (130) to be water-treated.

In addition, in this embodiment, a seventh flow path (WL7) fluidically connected to the flow path control valve (V) of the faucet 300 to be described later may be connected to the main module-side water treatment unit 130. As a result, the purified water treated by the main module-side water treatment unit 130 may be introduced through the seventh flow path (WL7) to the flow path control valve (V).

Meanwhile, referring back to FIGS. 1 to 3, the sub-module 200 of the under-sink water purifier 1 according to an exemplary embodiment of the present invention may be configured to treat and provide the purified water generated by the main module 100.

To this end, the sub-module 200 may include a sub-housing 210 and a sub-module-side water treatment unit 240 accommodated inside the sub-housing 210.

In this embodiment, the sub-housing 210 is made of a box-shaped structure with a rectangular parallelepiped shape. And, the sub-housing 210 may be coupled to the main housing 110 of the main module 100 such that one sidewall thereof faces the main housing 110. Hereinafter, when the sub-module 200 is coupled to the main module 100, one sidewall of the sub-module 200 facing the main module 100 is referred to as a corresponding wall 212.

As such, according to the present embodiment, as the corresponding wall 212 of the sub-housing 210 and the first sidewall 112 of the main housing 110 are arranged adjacent to each other, the sub-module 200 and the main module 100 are configured to be coupled to each other, allowing the sub-module 200 and the main module 100 to be compactly arranged within the internal space (S) (shown in FIG. 1) of the sink 2 (shown in FIG. 1). Accordingly, according to an exemplary embodiment of the present invention, the space utilization of the internal space (S) (shown in FIG. 1) of the sink 2 (shown in FIG. 1) may be enhanced.

Meanwhile, the shape of the sub-housing 210 is not limited to the aforementioned box-shaped structure and may be modified into various shapes, such as having a partially curved portion as needed.

In this embodiment, the sub-module-side water treatment unit 240 may be configured with various known structures capable of treating the purified water supplied as described above. For example, the sub-module-side water treatment unit 240 may be composed of a hot water generation unit, a cold water generation unit, a carbonated water generation unit, a flavor addition unit, or the like.

As such, according to an exemplary embodiment of the present invention, multiple sub-modules 200 capable of providing different water treatment functions may be provided, and only some of these sub-modules 200 may be selectively coupled to the main module 100 for use. This can satisfy the user's need to selectively receive only the desired functions.

In this case, it is preferable that the sub-module-side water treatment unit 240 and the main module-side water treatment unit 130 are configured to provide different functions, so as to provide purified water with various characteristics to the user.

For example, if the main module-side water treatment unit 130 is a hot water generation unit for generating hot water, the sub-module-side water treatment unit 240 may be configured as a cold water generation unit for generating cold water.

Accordingly, according to the under-sink water purifier 1 according to an exemplary embodiment of the present invention, it is possible to meet the needs of consumers who wish to receive purified water that has been treated in various ways.

Meanwhile, in order for the purified water to be supplied to the sub-module-side water treatment unit 240, the sub-module 200 needs to be fluidically connected to the main module 100. Furthermore, in order to ensure that the fluidic connection between the sub-module 200 and the main module 100 is maintained stably, the sub-module 200 needs to be structurally coupled to the main module 100.

To this end, in this embodiment, the sub-module 200 may be provided with a corresponding coupling part 220 and a corresponding water inlet member 230.

Referring to FIGS. 3 and 4, the lower front side of the sub-housing 210 may be provided with a corresponding water inlet member 230. The corresponding water inlet member 230 is a component for receiving purified water from the outside. The corresponding water inlet member 230 may be formed of a pipe, valve, or the like, through which fluid can flow internally.

In this case, in this embodiment, the corresponding water inlet member 230 may penetrate through the sub-housing 210. Additionally, one end of the corresponding water inlet member 230 may protrude outward from the sub-housing 210. Accordingly, the corresponding water inlet member 230 may be fittingly coupled to the first water discharge member 150 of the main module 100, thereby being fluidically connected.

Furthermore, an eighth flow path (WL8) may be provided between the corresponding water inlet member 230 and the sub-module-side water treatment unit 240. The eighth flow path (WL8) may fluidically connect the corresponding water inlet member 230 and the sub-module-side water treatment unit 240, so that the purified water introduced into the corresponding water inlet member 230 can be supplied to the sub-module-side water treatment unit 240.

Referring to FIGS. 4 to 7, in this embodiment, the corresponding coupling part 220 may include an insertion member 222 and a locking protrusion 224.

According to an exemplary embodiment of the present invention, as shown in FIG. 7, the insertion member 222 may be formed as one sidewall extending outward to surround the corresponding water inlet member 230. In this case, the outer portion of the insertion member 222 may have a rectangular cross-section corresponding to the first coupling groove 142a of the main module 100.

Additionally, in this embodiment, the locking protrusion 224 may be formed on the outer surface of the insertion member 222. In this case, the locking protrusion 224 may be formed such that the protruding height of its outer portion gradually decreases toward the end of the insertion member 222.

Accordingly, when the insertion member 222 of the sub-module 200 is press-fitted into the first coupling groove 142 a of the main module 100, the outer portion of the locking protrusion 224 may push one side of the first locking member 144 inward into the first through hole 142b.

At the same time, the end of the corresponding water inlet member 230 of the sub-module 200 may be inserted into the first water discharge member 150 of the main module 100, allowing the sub-module 200 and the main module 100 to be fluidically connected. That is, a state may be achieved in which purified water may flow from the main module 100 into the sub-module 200.

Furthermore, when the end of the insertion member 222 reaches the bottom surface of the first coupling groove 142a, the first locking member 144 no longer contacts the outer portion of the locking protrusion 224, allowing the first locking member 144 to protrude inward into the first coupling groove 142a and move to the engagement position.

The side of the locking protrusion 224 engages with the first locking member 144, which is protruded inward into the first coupling groove 142a, thereby restraining the corresponding coupling part 220 from coming out of the first coupling groove 142a.

Accordingly, the main module 100 and the sub-module 200 can be structurally coupled, and the fluidic connection between the main module 100 and the sub-module 200 can be stably maintained by the aforementioned structural coupling.

When an external force is applied such that the first operating member 146 is press-fitted inward into the main housing 110 while the main module 100 and the sub-module 200 are in the inserted state, the first locking member 144 moves to the disengagement position. Accordingly, the restraint of the corresponding coupling part 220 by the first locking member 144 is released, allowing the structural coupling between the sub-module 200 and the main module 100 to be released.

As such, according to this embodiment, the main module 100 and the sub-module 200 may be detachably coupled by the first coupling part 140 and the corresponding coupling part 220. Meanwhile, the structure for detachably coupling the main module 100 and the sub-module 200 is not limited to the first coupling part 140 and the corresponding coupling part 220 as shown, and various structures that can detachably couple the main module 100 and the sub-module 200 may be applied.

According to the above, the under-sink water purifier 1 according to an exemplary embodiment of the present invention allows for the fluidic connection/disconnection and structural coupling/detachment between the main module 100 and the sub-module 200 to be easily and simultaneously achieved. Therefore, the sub-module 200 and the main module 100 can be easily and simply coupled or detached without requiring specialized knowledge.

In this embodiment, the first operating member 146 is positioned at the second portion 112b of the first sidewall 112 of the main module 100. Accordingly, even when the main module 100 and the sub-module 200 are adjacent and coupled to each other, access to the first operating member 146 can be achieved. Therefore, according to the present embodiment, the detachment and attachment of the main module 100 and the sub-module 200 can be easily operated and controlled.

As such, the under-sink water purifier 1 according to an exemplary embodiment of the present invention is configured so that the user can easily attach and detach the sub-module 200 from the main module 100 according to their preferences, allowing them to receive purified or treated purified water. Therefore, it can meet the diverse needs of consumers.

Meanwhile, referring back to FIG. 3, in this embodiment, the sub-module-side water treatment unit 240 may be fluidically connected to a ninth flow path (WL9), which is connected to the flow path control valve (V) of the faucet 300 to be described later. Accordingly, the purified water treated in the sub-module-side water treatment unit 240 can be supplied to the flow path control valve (V).

Referring to FIGS. 1 to 3, the under-sink water purifier 1 according to an exemplary embodiment of the present invention may include a faucet 300 installed above the sink 2.

In this embodiment, the faucet 300 may include a faucet housing 310, a third water discharge member 320, an ice generation unit 330, an ice discharge member 340, and a flow path control valve (V).

As shown in FIG. 1, the lower part of the faucet housing 310 may have a rectangular parallelepiped shape extending in the up-down direction. The upper part of the faucet housing 310 may have a shape that slightly protrudes forward. The shape of the faucet housing 310 may be variously modified as needed.

Meanwhile, in this embodiment, the faucet housing 310 may be provided with a flow path control valve (V) inside. The flow path control valve (V) may be made of various known valves that can selectively discharge one of the multiple incoming fluids.

The flow path control valve (V) may be fluidically connected to a tenth flow path (WL10). The tenth flow path (WL10) may be configured to allow the purified water discharged from the flow path control valve (V) to flow through it.

The flow path control valve (V) may receive purified water generated by the filter 120 from the second flow path (WL2), receive purified water treated by the main module-side water treatment unit 130 from the seventh flow path (WL.7), and receive purified water treated by the sub-module-side water treatment unit 240 from the ninth flow path (WL9).

And, the flow path control valve (V) may control the flow paths such that purified water flowing through either the second flow path (WL2), the seventh flow path (WL7), or the ninth flow path (WL9) can flow out through the tenth flow path (WL10).

In this case, in this embodiment, the tenth flow path (WI.10) may be fluidically connected to the third water discharge member 320 penetrating through the faucet housing 310. The third water discharge member 320 is configured to discharge purified water or treated purified water to the outside. The third water discharge member 320 may be formed of a pipe, a valve, or the like.

Meanwhile, although not shown, the faucet 300 may further include a controller for controlling the flow path control valve (V) and an operation panel for receiving signals from the outside.

Such a controller may be implemented by a processor, a central processing unit (CPU), a controller, an arithmetic logic unit, a computational digital signal processing device, a microcomputer, an FPGA, a system-on-chip (SoC), a programmable logic unit, a microprocessor, or the like.

The operation panel may include buttons or a touch screen that a user can manipulate to input signals from the outside. Such an operation panel may be electrically connected to the aforementioned controller and may be configured to transmit externally input signals to the controller. Accordingly, the controller may control the flow path control valve (V) based on the input signal, reflecting the user's intent.

Meanwhile, referring again to FIGS. 1 to 3, the faucet 300 may further include an ice generation unit 330 and an ice discharge member 340. The ice generation unit 330 is configured to receive purified water from the flow path control valve (V) and generate ice. To this end, the ice generation unit 330 may be fluidically connected to the flow path control valve (V) via an eleventh flow path (WL11).

Additionally, the ice generation unit 330 may be connected to an ice discharge passage (IL). The ice discharge passage (IL) may be connected to the ice discharge member 340 provided in the faucet housing 310. The ice discharge member 340 may penetrate through the faucet housing 310. Accordingly, the ice generated in the ice generation unit 330 can be discharged to the outside.

As such, the under-sink water purifier 1 according to an exemplary embodiment of the present invention can be configured to provide ice according to the user's preference, thereby meeting various user needs.

Meanwhile, referring to FIG. 1 and FIG. 4, as previously examined, the sub-module 200 of the under-sink water purifier 1 according to an exemplary embodiment of the present invention may be arranged adjacent to the left side of the main module 100 and coupled thereto.

However, the shape of the internal space (S) provided in the sink 2 may vary depending on the structure of the sink 2. Therefore, the relative arrangement of the main module 100 and the sub-module 200 may need to be appropriately adjusted according to the shape of the internal space (S).

Referring to FIG. 2, FIG. 8, and FIG. 9, as described above, the under-sink water purifier 1 according to an exemplary embodiment of the present invention includes a second coupling part 160 and a second water discharge member 170 provided on the second sidewall 114 of the main module 100. Therefore, by simply rotating the sub-module 200 so that the corresponding wall 212 of the sub-module 200 faces the second sidewall 114, the sub-module 200 may be positioned adjacent to the right side of the main module 100 and coupled thereto.

In this way, the under-sink water purifier 1 according to an exemplary embodiment of the present invention can adjust the relative arrangement of the main module 100 and the sub-module 200 to fit the shape of the internal space (S) of the sink 2, allowing it to be appropriately installed in sinks 2 of various structures.

In addition, the under-sink water purifier 1 according to an exemplary embodiment of the present invention can increase the space utilization of the internal space (S) of the sink 2 by appropriately adjusting the relative arrangement of the main module 100 and the sub-module 200.

Furthermore, as shown in FIG. 8, even when the sub-module 200 is arranged adjacent to and coupled to the main module 100, the second operating member 166 of the second coupling part 160 is exposed to the outside, making it accessible. As a result, the user can easily and conveniently detach and attach the main module 100 and the sub-module 200.

Of course, although not shown, it is also possible that a plurality of sub-modules 200 may be provided, and multiple sub-modules 200 may be simultaneously coupled to both sides of the main module 100. Through this, by providing purified water treated in various ways, the needs of the user can be satisfied.

Hereinafter, a modified example of an under-sink water purifier according to an exemplary embodiment of the present invention will be described.

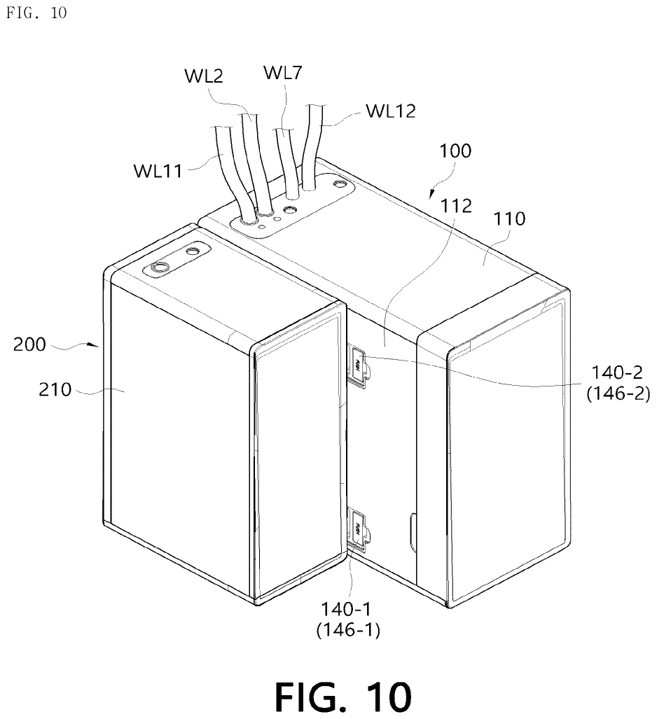

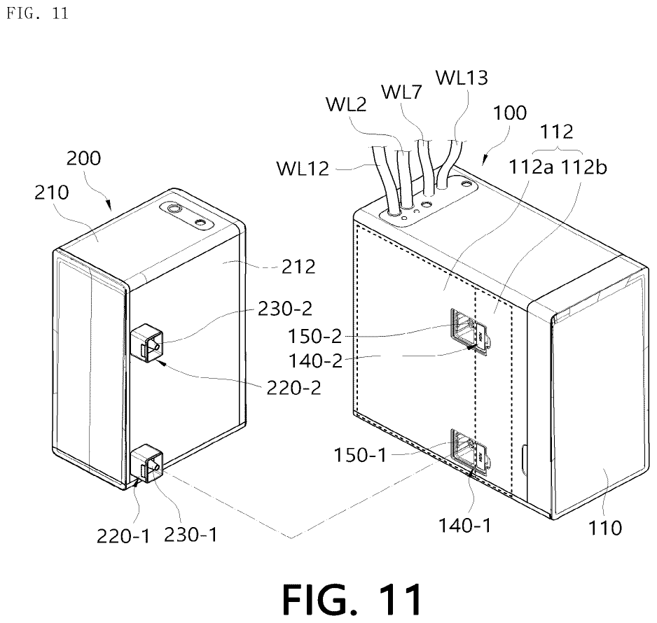

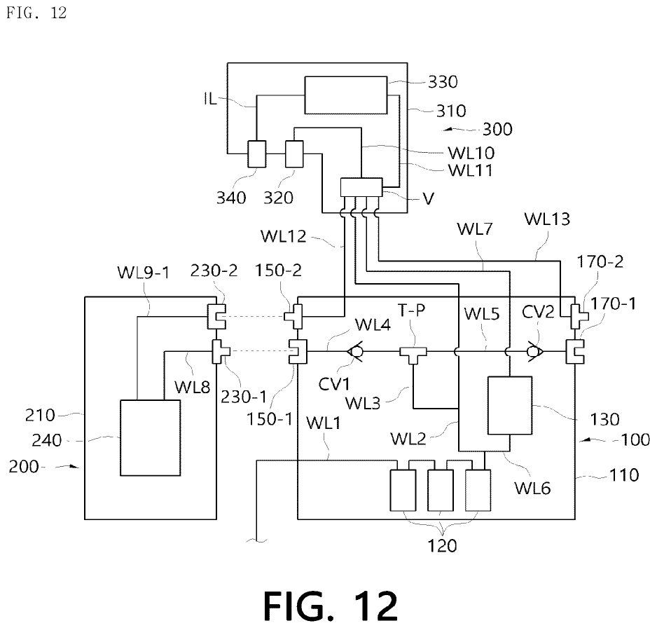

FIG. 10 is a perspective view from above showing a main module and a sub-module coupled to the left side of the main module, according to a modified example of the embodiment of the present invention. FIG. 11 is an exploded perspective view of the main module and sub-module shown in FIG. 10. FIG. 12 is a schematic diagram illustrating an under-sink water purifier according to a modified example of the embodiment of the present invention.

Referring to FIGS. 10 to 12, the under-sink water purifier according to this modified example is an under-sink water purifier that can configure the flow path between the faucet 300, the main module 100, and the sub-module 200 in a simpler manner.

In this modified example, a first-1 coupling part 140-1 and a first-2 coupling part 140-2 may be disposed to be spaced apart from each other in the up-down direction on the first sidewall 112 of the main housing 110. In addition, a first water discharge member 150-1 is provided on one side of the first-1 coupling part 140-1, and a first water inlet member 150-2 may be provided on one side of the first-2 coupling part 140-2.

The first water inlet member 150-2 and the flow path control valve (V) may be fluidically connected to each other through a twelfth flow path (WL12). Accordingly, the purified water flowing through the first water inlet member 150-2 may be introduced into the flow path control valve (V).

Likewise, a second-1 coupling part and a second-2 coupling part may be disposed to be spaced apart from each other in the up-down direction on the second sidewall 114 of the main housing 110. And, a second water discharge member 170-1 may be provided on one side of the second-1 coupling part, and a second water inlet member 170-2 may be provided on one side of the second-2 coupling part.

The second water inlet member 170-2 and the flow path control valve (V) may be fluidically connected to each other through a thirteenth flow path (WL13). Accordingly, the purified water flowing through the second water inlet member 170-2 may be introduced into the flow path control valve (V).

Referring again to FIGS. 10 to 12, in this modified example, a first corresponding coupling part 220-1 and a second corresponding coupling part 220-2 may be disposed to be spaced apart from each other in the up-down direction on the corresponding wall 212 of the sub-module 200.

In this case, the position of the first corresponding coupling part 220-1 of the sub-module 200 may be adjusted to face the first-1 coupling part 140-1 of the main module 100. In addition, the position of the second corresponding coupling part 220-2 of the sub-module 200 may be adjusted to face the first-2 coupling part 140-2 of the main module 100.

In addition, a corresponding water inlet member 230-1 may be provided on one side of the first corresponding coupling part 220-1, and a corresponding water discharge member 230-2 may be provided on one side of the second corresponding coupling part 220-2.

Referring to FIG. 12, in this modified example, a ninth flow path (WL9-1) may be connected to the sub-module-side water treatment unit 240 of the sub-module 200. However, unlike the previously described embodiment, the ninth flow path (WL9-1) may be fluidically connected to the aforementioned corresponding water discharge member 230-2.

Accordingly, according to this modified example, if the sub-module 200 is coupled to the left side of the main module 100, the first water discharge member 150-1 and the corresponding water inlet member 230-1 may be fluidically connected. And, when the corresponding water discharge member 230-2 and the first water inlet member 150-2 are fluidically connected, the purified water treated by the sub-modulo-side water treatment unit 240 may be introduced back into the main module 100 through the ninth flow path (WL9-1). Accordingly, the purified water introduced into the main module 100 may be introduced into the flow path control valve (V) through the twelfth flow path (WL12).

If the sub-module 200 is coupled to the right side of the main module 100, the second water discharge member 170-1 and the corresponding water inlet member 230-1 may be fluidically connected. And, when the corresponding water discharge member 230-2 and the second water inlet member 170-2 are fluidically connected, the purified water treated by the sub-module-side water treatment unit 240 may be introduced back into the main module 100 through the ninth flow path (WL9-1). Accordingly, the purified water introduced into the main module 100 may be introduced into the flow path control valve (V) through the thirteenth flow path (WL13).

As such, according to this modified example, since the flow path is adjusted so that the faucet 300 can receive both purified water and treated purified water from the main module 100, the flow path between the faucet 300, the main module 100, and the sub-module 200 may be configured more simply.

Although exemplary embodiments of the present invention have been described above, the idea of the present invention is not limited to the embodiments set forth herein. Those of ordinary skill in the art who understand the idea of the present invention may easily propose other embodiments through supplement, change, removal, addition, etc. of elements within the scope of the same idea, but the embodiments will be also within the idea scope of the present invention.

1. A modular under-sink water purifier, comprising:
a main module provided in a sink; and
a faucet disposed outside the sink, wherein the main module comprises:
a main module housing having a first coupling part and a second coupling part provided, respectively, at one side portion and the other side portion thereof so that a portion of a sub-module, which can be detachably coupled to the main module, can be selectively coupled thereto;
filters provided in the main module housing, and filtering raw water so as to produce purified water ; and
a first water discharge member and a second water discharge member provided, respectively, at one side of the first coupling part and one side of the second coupling part so that the purified water produced by means of the filters can be discharged to the outside of the main module housing, and
wherein the faucet comprises:
a faucet housing; and
a third water discharge member provided at the faucet housing so that the purified water supplied from the filters can be discharged to the outside.

2. The under-sink water purifier of claim 1,
wherein the first coupling part comprises:
a first bracket provided with a first coupling groove into which a portion of the sub-module can be inserted;
a first locking member that is movably coupled to the first bracket, enabling movement to a locking position where the portion of the sub-module is engaged and a locking release position where the portion of the sub-module is spaced apart from the portion of the sub-module; and
a first operating member provided on one side of the first locking member to allow movement of the first locking member, and
wherein one side of the first water discharge member is positioned inside the first coupling groove.

3. The under-sink water purifier of claim 2,
wherein one side of the first operating member is provided with a button exposed to the outside of the main module housing, and
wherein the button is configured to move the first operating member by being pressed inward into the main module housing by an external force, with one side of the button being connected to the first operating member.

4. The under-sink water purifier of claim 2,
wherein the outer side of the main module housing comprises a first sidewall provided with the first coupling part,
wherein the first sidewall comprises a first portion adjacent to the sub-module coupled to the first coupling part and a second portion provided at an edge of the first portion,
wherein the first coupling groove is disposed on the first portion of the first sidewall, and
wherein the first operating member is disposed on the second portion of the first sidewall.

5. The under-sink water purifier of claim 4,
wherein the second coupling part comprises:
a second bracket provided with a second coupling groove into which a portion of the sub-module can be inserted;
a second locking member that is movably coupled to the second bracket, enabling movement to a locking position where the portion of the sub-module is engaged and a locking release position where the portion of the sub-modulo is spaced apart from the portion of the sub-module; and
a second operating member provided on one side of the second locking member to allow movement of the second locking member, and
wherein one side of the second water discharge member is positioned inside the second coupling groove.

6. The under-sink water purifier of claim 5,
wherein the outer side of the main module housing comprises a second sidewall provided with the second coupling part,
wherein the second sidewall comprises a first portion adjacent to the sub-module coupled to the second coupling part and a second portion provided at an edge of the first portion,
wherein the second coupling groove is positioned on the second portion of the second sidewall, and
wherein the second operating member is positioned on the second portion of the second sidewall.

7. The under-sink water purifier of claim 6,
wherein the main module housing extends in the front-rear direction and has a box shape in which the first sidewall and the second sidewall are provided at opposite sides,
wherein the first operating member is positioned at the front portion of the first sidewall, and
wherein the second operating member is positioned at the rear portion of the second sidewall.

8. The under-sink water purifier of claim 1,
further comprising a first sub-module disposed adjacent to the main module,
wherein the first sub-module comprises:
a first sub-module housing having a first corresponding coupling part provided at one side thereof to be selectively coupled to one of the first coupling part and the second coupling part;
a first corresponding water inlet member provided at one side of the first corresponding coupling part to be selectively and fluidically connected to one of the first water discharge member and the second water discharge member ; and
a first sub-module-side water treatment unit configured to receive purified water from the first corresponding water inlet member and heat or cool it, and
wherein the third water discharge member is configured to receive the purified water cooled or heated by the first sub-module-side water treatment unit.

9. The under-sink water purifier of claim 8,
further comprising a second sub-module disposed adjacent to the main module,
wherein the second sub-module comprises:
a second sub-module housing having a second corresponding coupling part provided at one side thereof to be selectively coupled to the other one of the first coupling part and the second coupling part;
a second corresponding water inlet member provided at one side of the second corresponding coupling part to be selectively and fluidically connected to the other one of the first water discharge member and the second water discharge member; and
a second sub-module-side water treatment unit configured to receive purified water from the second corresponding water inlet member and heat or cool it, and
wherein the third water discharge member is configured to receive the purified water cooled or heated by the second sub-module-side water treatment unit.

10. The under-sink water purifier of claim 9,
wherein the first sub-module-side water treatment unit is a cold water generation unit configured to cool purified water to generate cold water, and
wherein the second sub-module-side water treatment unit is a hot water generation unit configured to heat purified water to generate hot water.

11. The under-sink water purifier of claim 1,
wherein the main module housing comprises a first sidewall provided with the first coupling part and a second sidewall provided with the second coupling part, and
wherein the first sidewall and the second sidewall are disposed to face each other.

12. The under-sink water purifier of claim 1,
wherein the main module comprises:
a main module-side water treatment unit provided inside the main module housing and configured to receive purified water from the filters and perform heating or cooling.

13. The under-sink water purifier of claim 1,
wherein the faucet comprises:
an ice generation unit configured to receive purified water from the filters and generate ice; and
an ice discharge member configured to discharge the ice generated by the ice generation unit to the outside.

14. The under-sink water purifier of claim 1,
wherein the main module comprises:
a piping member having a purified water inlet portion configured to receive purified water from the filters; a first extension portion extending in one direction from one side of the purified water inlet portion to supply purified water to the first water discharge member; and a second extension portion extending in the opposite direction from the one side of the purified water inlet portion to supply purified water to the second water discharge member.

15. The under-sink water purifier of claim 1, wherein a check valve is provided on one side of the first water discharge member and the second water discharge member, respectively, the check valve being configured to prevent purified water from being discharged to the outside of the main module housing when the sub-module is not coupled to the main module.

16. The under-sink water purifier of claim 1,
wherein the main module comprises:
a third coupling part and a fourth coupling part provided on the outer side of the main module housing to allow another part of the sub-module to be selectively coupled thereto; and
a first water inlet member and a second water inlet member respectively provided on one side of the third coupling part and one side of the fourth coupling part to allow purified water discharged from the sub-module to be introduced into the main module housing,
wherein the third coupling part is disposed to be spaced apart from one side of the first coupling part, and
wherein the fourth coupling part is disposed to be spaced apart from one side of the second coupling part.

17. The under-sink water purifier of claim 16,
further comprising a first sub-module disposed adjacent to the main module,
wherein the first sub-module comprises:
a first sub-module housing having a first water inlet-side corresponding coupling part selectively coupled to one of the first coupling part and the second coupling part, and a first water discharge-side corresponding coupling part selectively coupled to one of the third coupling part and the fourth coupling part, the first water inlet-side corresponding coupling part and the first water discharge-side corresponding coupling part being provided on the outer side of the first sub-module housing;
a first corresponding water inlet member provided at one side of the first water inlet-side corresponding coupling part to be selectively and fluidically connected to one of the first water discharge member and the second water discharge member ;
a first sub-module-side water treatment unit configured to receive purified water from the first sub-module-side water inlet member and heat or cool it; and
a first corresponding water discharge member provided on the first water discharge-side corresponding coupling part to be selectively and fluidically connected to one of the first water inlet member and the second water inlet member so as to discharge purified water, supplied from the first sub-module-side water treatment unit, to the outside of the first sub-module housing,
wherein the first water discharge-side corresponding coupling part is disposed to be spaced apart from one side of the first water inlet-side corresponding coupling part, and
wherein the third water discharge member is configured to receive the purified water cooled or heated by the first sub-module-side water treatment unit.
